(19) United States
(12) Patent Application Publication
(10) Pub. No.: US 2020/0159167 A1
(43) Pub. Date: May 21, 2020

(54) In-Line Test System For A Holographic Optical Element

(71) Applicant: LUMINIT LLC, TORRANCE, CA (US)

(72) Inventors: MATTHEW STEVENSON, LONG BEACH, CA (US); JUAN RUSSO, TORRANCE, CA (US); SETH COE-SULLIVAN, TORRANCE, CA (US)

(21) Appl. No.: 16/688,122

(22) Filed: Nov. 19, 2019

Related U.S. Application Data
(60) Provisional application No. 62/769,279, filed on Nov. 19, 2018.

(51) Int. Cl. G03H 1/04; G02B 5/32; G02B 27/01

(52) U.S. Cl. CPC G03H 1/0404; G02B 5/32; G02B 27/0103; G03H 1/041; G03H 1/0486

(57) ABSTRACT

This application discloses an in-line system and method for measuring the optical performance of an HOE in motion during a roll-to-roll fabrication process.

### CROSS-REFERENCE TO RELATED APPLICATIONS

This application claims priority to U.S. Provisional Patent Application No. 62/769,279, filed Nov. 19, 2018, the disclosure of which is incorporated by reference in its entirety herein.

### TECHNICAL FIELD

This application is directed to a system and method for the optical and cosmetic measurement of a holographic optical element (HOE) in motion during a roll-to-roll fabrication process.

### BACKGROUND

It is estimated that the combined revenues for sales of augmented reality (AR), virtual reality (VR) and smart glasses will approach $80 billion by the year 2025. About half of that revenue is directly proportional to hardware of the devices and the optics are key. However, despite this popularity and huge demand, such devices remain difficult to manufacture. One reason is that traditional optical elements are limited to the laws of refraction and reflection, which require cumbersome custom optical elements that are difficult to fabricate to form a usable image in the wearer's visual field. Another reason is that refractive optical materials are heavy in weight. Yet another reason is that reflective optical trains result in bulky and nonergonomic designs. These limitations of traditional optical elements result in devices that are less than satisfactory to the public.

In contrast to conventional optics, the flexibility provided by HOE fabrication allows production of an attractive, conformable, useful, and easy to use consumer electronic product. HOEs are thin and can be custom fabricated for ergonomic input and output angles with relative ease. HOEs such as Luminit® Transparent Holographic Components™, are transparent, light, thin, and allow for arbitrary incident and diffraction angles. As HOEs become mass-produced, it would be highly advantageous to have the capability to monitor the both the performance and quality of HOEs quickly, easily, and accurately in a mass production environment.

In the HOE domain, narrow angular and spectral performance is often referred to as transparency. In other words, the wearer has an unobstructed view of the environment (AR) or of another display (VR) while the optical system overlays specific images and information. Volume HOEs operating in the thick regime are especially suited to provide the required transparency while overlaying the images with high efficiency. Although surface relief diffractive optical elements are easy to manufacture by embossed replication, they add scattering and multiple diffraction orders, causing ghosting, reducing efficiency, and compromising see-through operation. Conversely, thick volumetric HOEs can be designed to diffract in only one order with minimal scattering, eliminating ghosting, and maximizing efficiency and see-through transparent performance. Like surface relief structures, volume HOEs can be manufactured in master and replication schemes. These applications provide an important avenue for diffractive optical element penetration into the consumer electronics markets with high part volume and reliability requirements. Volume HOEs are particularly crucial for the AR and HUD segments, where transparency is necessary in terms of performance and cosmetic appearance.

Currently, the monitoring of the performance and quality of HOEs is cumbersome and time-consuming in the performance of the individual testing, in the analysis of the data, and in the interruption of the manufacturing process. As part of the mass-production of HOEs, it is desirable to evaluate the optical performance and cosmetic appearance of the diffracted beam of the HOEs. Additionally, it is useful to identify parts that have gross defects. These parts are manufactured in a roll-to-roll process and move past the testing location with a constant velocity. Additionally, the web of material that the parts are produced upon can drift back and forth in the machine. Thus, there exists a need for an effective solution to the problem of the inability to test the performance and quality of HOEs quickly, simply, and precisely, which the present system addresses.

### BRIEF SUMMARY

The present application is directed to an automated system for the measurement of cosmetic and optical performances of a holographic optical element. This system comprises one or more stations that perform in-line measurements. Some of the stations include (a) a camera in conjunction with a light source; (b); a spectrometer in conjunction with a broadband light source and optics; (c) a second camera in conjunction with a narrowband incoherent light source and optics; and (d) a track for movement of the holographic optical element throughout the system.

The stations function as recognizing individual part numbers of the holographic optical element, monitoring cosmetic defects of the holographic optical element, evaluating a measurement of the performance of the holographic optical element, and capturing an image of the diffracted beam of the holographic optical element.

Yet another embodiment is directed to a method of measuring optical performance of a holographic optical element comprising one or more in-line or in-motion steps: (a) recognizing part numbers of the holographic optical element, (b) monitoring cosmetic defects of the holographic optical element, (c) evaluating a performance of the holographic optical element, and (d) capturing an image of a diffracted beam of the holographic optical element.

The test system of this application has several benefits and advantages. One benefit is the quick speed as to which the HOEs can be evaluated in-line. Another benefit is that the system is easy to use in comparison to several independent tests. The system described here was developed to measure the performance of these parts in a roll-to-roll, moving environment and provide a way to certify product performance quickly and easily prior to shipment.

### BRIEF DESCRIPTION OF THE DRAWINGS

FIG. 1 illustrates a system consisting of three stations mounted sequentially along the web in the direction of web motion.

FIG. 2 illustrates a station comprising a standard camera that captures an overall image of the part as it moves past and reads the part barcode to determine the part number for use in logging in.

FIG. 3 illustrates an example of the output from the standard camera that captures an overall image of the part as it moves past and reads the part barcode.

FIG. 4 illustrates a station for white light measurement of the HOE.

FIG. 5 is a collection of data showing an example of real data taken from moving parts with the test system.

FIG. 6 illustrates statistical analysis of the data illustrating the narrow distribution of performance results measured with this system on a moving web.

FIG. 7 is an illustration of the Diffracted Beam Imaging station.

FIG. 8 is an example of the image quality from use of the system.

FIG. 9 is a photo of the system overall.

FIG. 10 is a photo of the camera station.

FIG. 11 is a photo of the white light measurement station.

FIG. 12 is a photo of the diffracted beam imaging station.

FIG. 13 is a photo of a collection of holographic optical elements with matching performance characteristics with square shape and markings.

FIG. 14 is a photo of a collection of holographic optical elements with matching performance characteristics, circular shape, and individually marked.

FIG. 15 is a photo of a collection of holographic optical elements with matching performance characteristics, circular shape, and individually marked.

FIG. 16 is a photo of a collection of nine holographic optical elements with matching performance characteristics in a sheet, individually marked.

FIG. 17 is a photo of a collection of 175 holographic optical elements with matching performance characteristics in a roll, individually marked.

### DETAILED DESCRIPTION OF EXEMPLARY EMBODIMENTS

The present application relates to a system and method for accurately measuring the optical performance of an HOE in a mass production environment. The system can be advantageously used to accurately monitor the quality of mass quantities of HOEs, which former processes were time-consuming, ineffective, and problematic. The apparatus described here provides meticulous, detailed information on the quality of the HOEs in a rapid timeframe. The current application describes a system that can perform all of these required measurements on moving parts while adjusting for lateral drift in the web.

In particular, the system described here facilitates the optical and cosmetic measurement of holographic optical elements (HOEs) in motion during a roll-to-roll fabrication process. The system is designed to log individual part numbers, capture an image of each part to check for gross cosmetic defects, perform an in-line measurement of HOE performance, and to capture an image of the diffracted beam of the HOE being tested.

In order for the system to provide accurate data, it also needs to be able to calculate the position of each part relative to the overall machine and then adjust the position of the test equipment (using motorized stages) to align the system properly for each measurement. Additionally, it has a means by which to repeatably measure the performance of an HOE actively moving past the test equipment.

In one embodiment, the system includes an automated, in-line system for analyzing performance of a HOE containing (a) a camera in conjunction with a light source; (b); a spectrometer in conjunction with a broadband light source and optics; (c) a second camera in conjunction with a narrowband incoherent light source and optics; and (d) a track for movement of the holographic optical element throughout the system. In one embodiment, the camera has resolution to 0.1 mm or less and the broad band light source comprises an LED light. The spectrometer comprises a spectral range in the ultra-violet, visible, and/or near infra-red and spectral accuracy of less than or equal to 0.5 nm. In one embodiment, the light comprises a beam of about 2-3 mm. In another embodiment, the system further comprises a narrow band filter having a bandwidth of about 2-3 nm or less. The system can also include a diffusive sheet in addition to or in place of a camera.

During operation of the system, the position of the HOE entering and moving through the system is monitored and adjusted for by rotational and translational stages as the HOE travels through the system on a web or track. In another embodiment, operation of the system is triggered by machine-vision reading of a fiducial mark on the HOE to begin analysis of the HOE. A computer can be used for storage and analysis of data regarding the HOE collected by the system and the system can be mounted on base.

The in-line measurements encompass: (a) recognizing a part number of the holographic optical element; (b) analyzing the holographic optical element for a cosmetic defect; (c) evaluating a measurement of a performance of the holographic optical element; and (d) capturing an image of a diffracted beam of the holographic optical element. Each component of the system can take multiple analyses of the holographic optical element.

The system can further include an integrating sphere to capture light diffracted by the holographic optical element, which provides measurements of diffraction efficiency, bandwidth, and peak diffraction wavelength for one or more colors. The integrating sphere has a size small enough to register sensitivity of the holographic optical element but large enough to eliminate angular dependence in data collection. In an alternate embodiment, the system can further include a marking mechanism for the holographic optical element. In another embodiment, the system contains fiber optics to connect the light source and the spectrometer. In yet another embodiment, the holographic optical element comprises a collection of holographic optical elements with matching performance characteristics.

Another embodiment is a system for the measurement of optical performance of a holographic optical element comprising one or more stations that perform in-line measurements comprising; (a) a first station for recognizing a part number of the holographic optical element; (b) a second station for monitoring a cosmetic defect of the holographic optical element; (c) a third station for evaluating a measurement of an optical performance of the holographic optical element; and (d) a fourth station for capturing an image of a diffracted beam of the holographic optical element.

Also contemplated herein is a method of measuring optical performance of a holographic optical element comprising one or more in-line or in-motion steps: (a) recognizing part numbers of the holographic optical element, (b) monitoring cosmetic defects of the holographic optical element, (c) evaluating a performance of the holographic optical element, and (d) capturing an image of a diffracted beam of the holographic optical element wherein drift of the HOE is automatically adjusted in-line by one or more translational and/or rotational stages.

### Examples

The system consists of three stations mounted sequentially along the web in the direction of web motion (FIG. 1). Any analysis described in the individual description for each station is performed by the control software, unless noted otherwise. Measurements are taken with machine vision from calibrated images via National Instruments Vision Builder 2015 software.

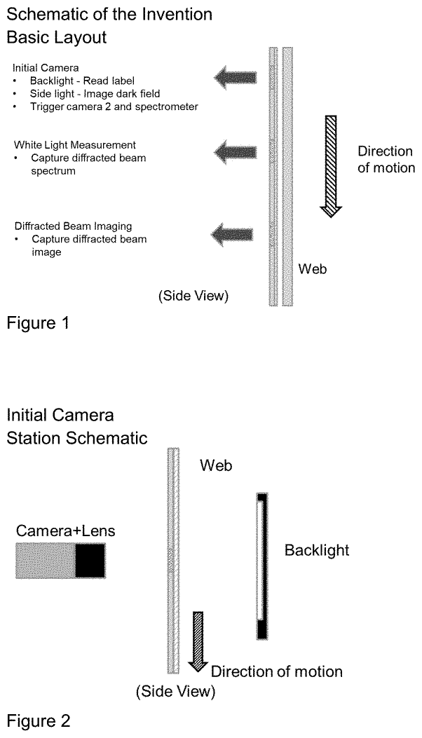

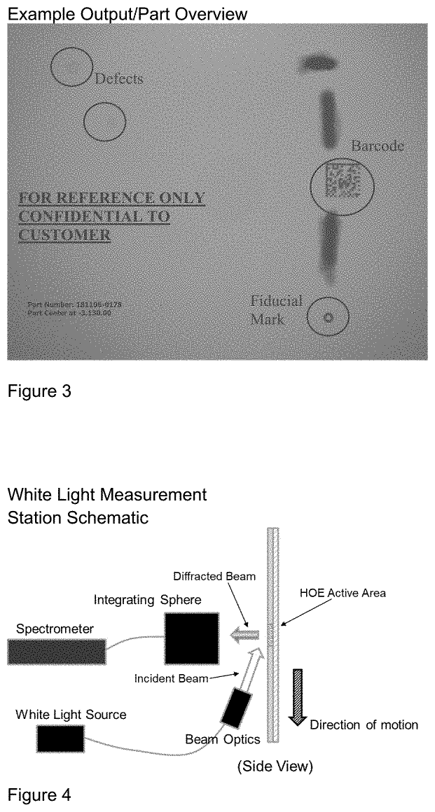

One of the stations (FIG. 2) comprises a standard camera that captures an overall image of the part as it moves past and reads the part barcode to determine the part number for use in logging of this and subsequent stages. Operation is triggered by machine-vision reading of fiducial marks on the part, and this trigger provides the timing that drives the other two sections. The image obtained by this step is used to document any gross cosmetic defects (i.e. bubbles, scratches) present on the part. This station also logs the cross-web position of each part and uses that information to adjust the location of the equipment used in the two subsequent stations to insure proper alignment with the part. The part is illuminated from behind by a uniform white backlight to achieve these goals. An example of the output is shown in FIG. 3.

Camera—The camera should have sufficient resolution to enable measurements of the image down to 0.1 mm. Currently using a Basler acA1300-200uc.
Lens—The requirement for the lens is that it needs to capture the required area of the part, and to have a depth-of-field sufficient to allow for +/−1 mm variations in web:camera distance during operation. Currently using a Computar M0814-MP2
Backlight—The backlight should provide a background of uniform illumination over the portion of the web of interest. Currently using a Metaphase 5.7″×10″ white LED backlight (Edmund Optics P/N 83-874)

Another station is shown in FIG. 4, which is for white light measurement of the HOE. The steps performed at this station are: adjust translation stage to align measurement system with part, based on measurements taken by the initial camera; project a −3 mm diameter beam of white light (incident beam) onto the center of the HOE under test; and measure the spectrum of the diffracted beam and extract performance parameters.

This station of the system projects a small beam of white light onto the sample and uses an integrating sphere to capture light diffracted by the HOE. Spectral analysis of this light provides performance information for each part such as diffraction efficiency, bandwidth, and peak diffraction wavelength for each color.

The web is moving past the measurement station during this measurement, which makes accurately timing the measurement to coincide with the beam being incident on the correct part of the sample more involved. When the integrating sphere is at the correct diffraction angle relative to the incident beam and the spot is on the correct spot on the HOE, the diffracted beam signal is maximized. To find where the signal is maximized, the system takes many short measurements of the spectrum and then selects the one with the largest overall intensity for analysis.

Additionally, the web can drift laterally during a run, which can easily cause parts to be misaligned left-to-right with respect to the HOE active area. To account for this, the program controlling the test refers to the fiducial position measured in the initial camera stage, and then uses this data to direct a motorized translation stage to adjust the position of the measurement station laterally to match the position of the HOE.

The hardware considerations of this station are as follows:

Spectrometer—the spectrometer used here should have a spectral range sufficient to account for the output wavelengths of interest to the hologram and a spectral accuracy of 0.5 mm or less. The current system uses a Thorlabs CCS100.

Integrating Sphere—the integrating sphere should be small enough to allow sensitivity to signals of the magnitude expected from the HOEs being tested, but large enough to properly eliminate any angular dependence in the data collection. Currently, a Thorlabs IS236A in used in the system.

White Light Source—The light source used here should provide broadband spectral output over the wavelength range of interest. Currently a Thorlabs MVVWHF2 fiber-coupled LED is used in the system.
Beam Optics—The beam optics are used to control the size of the incident beam and to collimate it somewhat. To this end, there exist a wide variety of combinations of irises, lenses, and mounting hardware that could be used to make the 3 mm diameter beam required by the current system.
Fiber Optics—The light source and the spectrometer are connected to the system via fiberoptic cables. As high light throughput and physical robustness are required in this application, it employs a Thorlabs FT1500umT cable with a fiber diameter of 1500 um and a stainless steel jacket to connect both of these elements to the system.

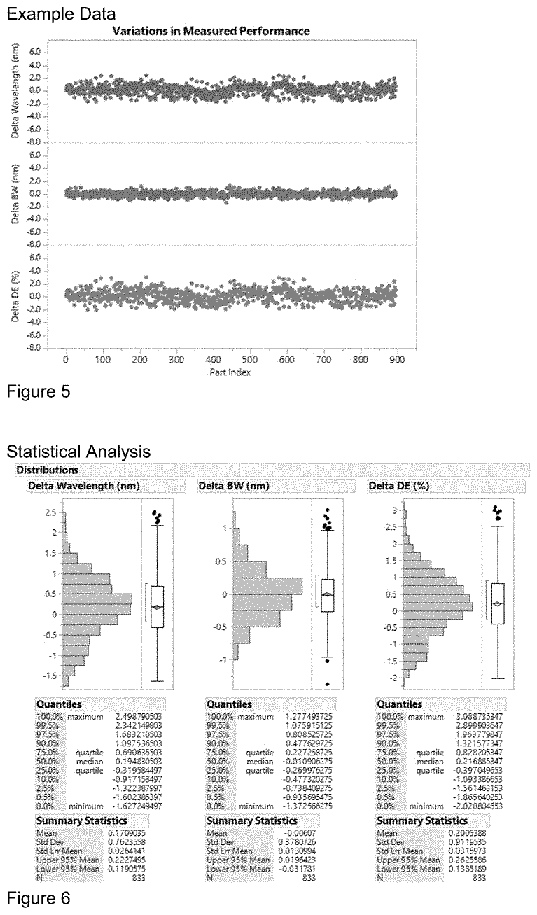

Shown in FIG. 5 is a collection of data showing an example of real data taken from moving parts with the test system described here. The data has been represented as a deviation from the average to avoid revealing customer confidential performance requirements. Shown in FIG. 6 is a statistical analysis of the data shown above illustrating the narrow distribution of performance results measured with this system on a moving web.

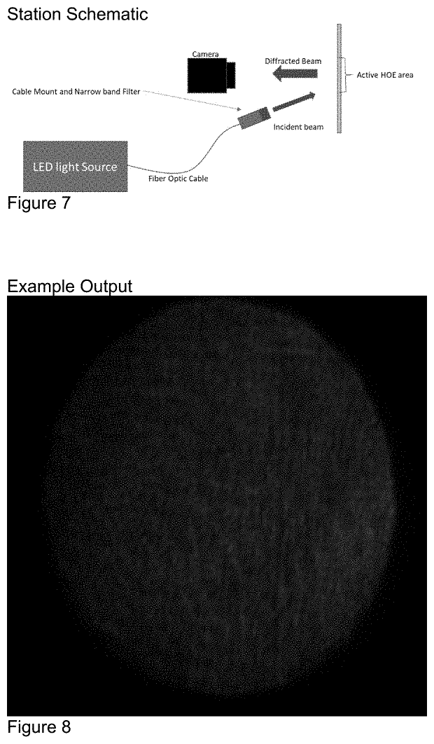

Another station is shown in FIG. 7, which is for Diffracted Beam Imaging. The hardware for this is optimized to capture image of parts in motion. This is achieved by adjusting the integration time of the system. Lateral alignment can also be achieved. This station uses a wide spot of nearly monochromatic, but incoherent light, to illuminate the HOE as it passes by. The light is diffracted by the HOE onto a camera and produces an image of the diffracted beam that reveals information about defects present in the HOE active area.

The individual components of this station are as follows:

LED light source: a monochrome LED is the one light source, and it can be used with an output suited to fiber coupling (i.e. SMA connector). An example part is the Thorlabs M625F2 for a red illuminator.
Fiber Optic Cable: The diameter of the fiber optic cable determines the level of detail in the image produced by the system. It has been observed that as the diameter of the fiber increases, the image produced highlights smaller-scale features. An example of a suitable cable is the Thorlabs M38L02.

Narrow band filter: One of the innovations described here is the ability to simulate laser illumination of the HOE and the corresponding image without actually using a laser light. One component for that is a narrow-band filter that reduces the light incident on the sample to a very narrow bandwidth (−2-3 nm). An example filter is Thorlabs FL632.83. Camera: The camera used here has two main requirements. It needs to be of sufficient resolution to capture the details of the image required (i.e. 2048×2048), and it needs to have a large sensor (0.5″×0.5″, for example). An example of a suitable camera is the Edmund Optics EO-4010 Monochrome USB 3.0 Camera. Depending on the angle of the diffracted beam relative to the incident beam, it may be necessary to modify the camera housing to allow the incident beam to pass unimpeded.

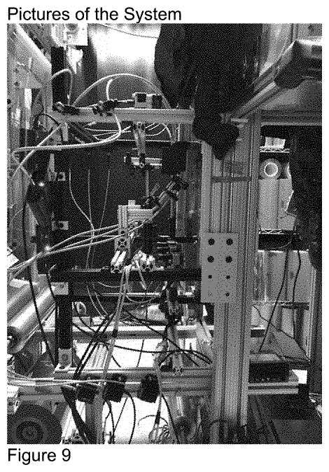

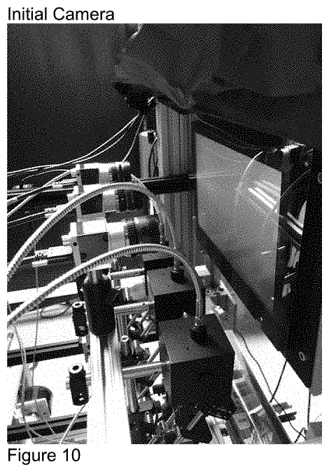

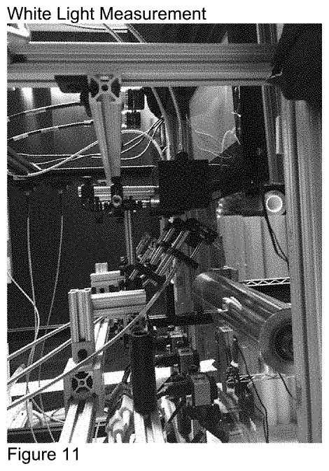

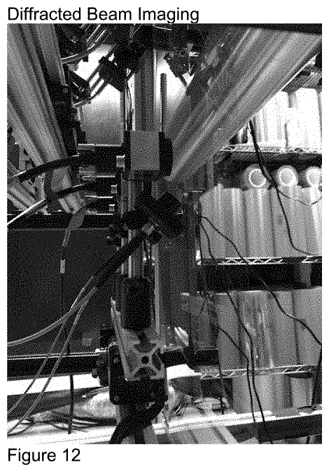

Overall Construction: The current system is constructed using a selection of Thorlabs optical mounting hardware and attached to a standard optical breadboard. The mounting hardware for the current version was chosen to allow adjustments during development, but one could easily consider a system where the components were mounted on custom-designed permanent hardware.
Alternative Method: If a suitable camera cannot be found, a diffusive sheet (i.e. Luminit 80 degree diffuser) can be placed in the camera location, and then a standard camera and lens used to capture the image displayed on the sheet. (see FIG. 8). FIG. 9 is a photo of the system overall. FIG. 10 is a photo of the camera station. FIG. 11 is a photo of the white light measurement station. FIG. 12 is a photo of the diffracted beam imaging station.

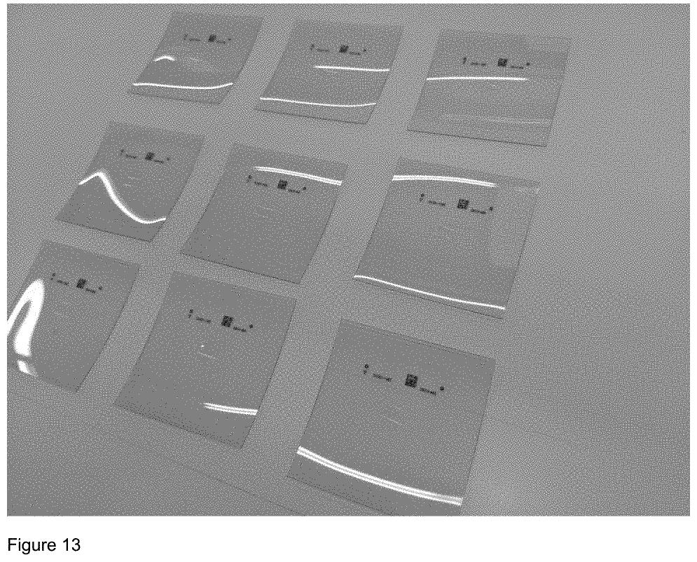

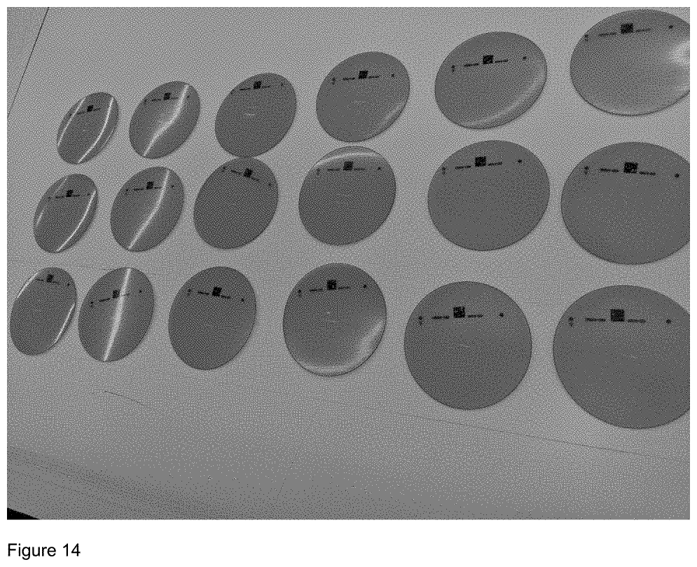

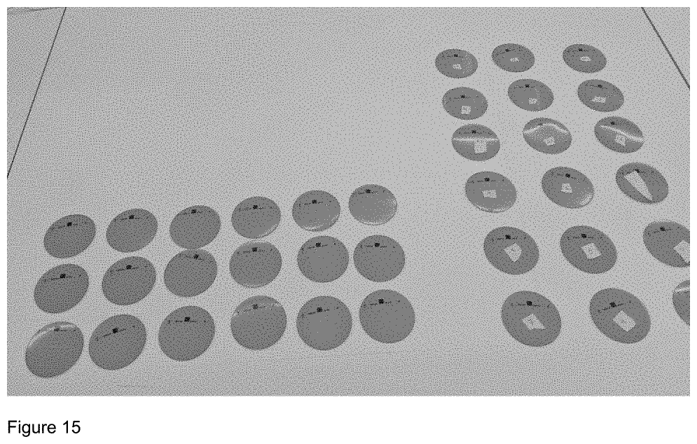

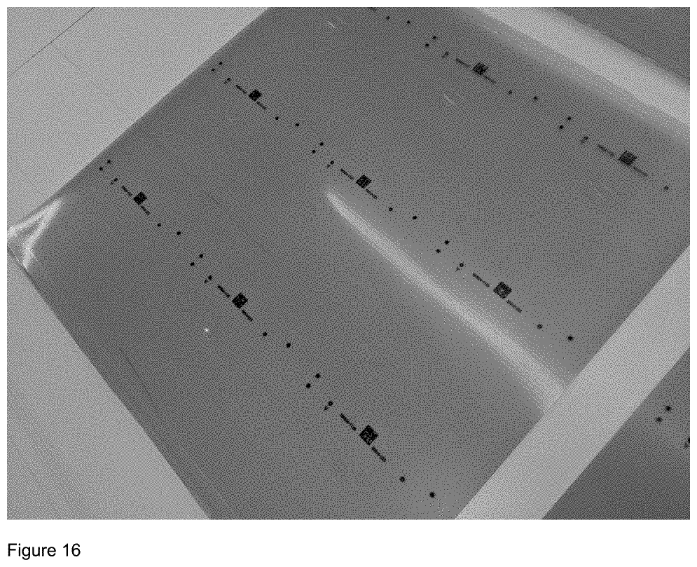

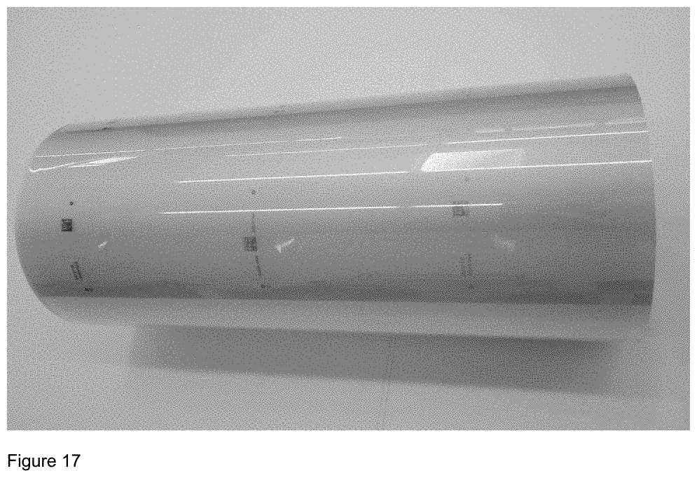

FIG. 13 is a collection of holographic optical elements with matching performance characteristics with square shape and markings. FIG. 14 is a collection of holographic optical elements with matching performance characteristics, circular shape, and individually marked. FIG. 15 is a collection of holographic optical elements with matching performance characteristics, circular shape, and individually marked. FIG. 16 is a collection of nine holographic optical elements with matching performance characteristics in a sheet, individually marked. FIG. 17 is a collection of 175 holographic optical elements with matching performance characteristics in a roll, individually marked.

Using the system and metrics described above, member holograms of a population of HOEs can be evaluated by:

(a) obtaining individual part numbers of the HOE;

(b) obtaining the number of cosmetic defects of the HOE;

(c) measuring the performance of the HOE;

(d) obtaining an image of a diffracted beam of the HOE; and

(e) grouping member holograms with similar number of cosmetic defects of the HOE.

Using the method and system described above, a collection of HOEs can be prepared by evaluating the member holograms and grouping member holograms into populations with similar numbers of cosmetic defects of the HOE.

The metrics and testing parameters, stations and systems described herein make it possible to fabricate a collection of one or more member holographic optical elements that have matching performance characteristics comprising (a) holograms fabricated with individual part numbers of the HOE; (b) number of cosmetic defects of the HOE; (c) performance of the HOE; and/or (d) image of a diffracted beam of the HOE.

Alternative embodiments of the subject matter of this application will become apparent to one of ordinary skill in the art to which the present invention pertains without departing from its spirit and scope. It is to be understood that no limitation with respect to specific embodiments shown here is intended or inferred.

We claim:

1. An automated, in-line system for analyzing performance of a holographic optical element comprising: (a) a camera in conjunction with a light source; (b); a spectrometer in conjunction with a broadband light source and optics; (c) a second camera in conjunction with a narrowband incoherent light source and optics; and (d) a track for movement of the holographic optical element throughout the system.

2. The system of claim 1 comprising an in-line system wherein a position of the holographic optical element entering and moving through the system is monitored and adjusted for by rotational and translational stages as the holographic optical element passes through the system.

3. The system of claim 1 wherein operation of the system is triggered by machine-vision reading of a fiducial mark on the holographic optical element to begin analysis of the holographic optical element.

4. The system of claim 1 further comprising a computer for storage and analysis of data.

5. The system of claim 1 wherein the in-line measurements comprise: (a) recognizing a part number of the holographic optical element; (b) analyzing the holographic optical element for a cosmetic defect; (c) evaluating a measurement of a performance of the holographic optical element; and (d) capturing an image of a diffracted beam of the holographic optical element.

6. The system of claim 1 wherein the scanner comprises a camera having resolution to 0.1 mm or less.

7. The system of claim 1 wherein the broadband light source comprises an LED light.

8. The system of claim 1 further comprising an integrating sphere to capture light diffracted by the holographic optical element, which provides measurements of diffraction efficiency, bandwidth, and peak diffraction wavelength for one or more colors.

9. The system of claim 1 wherein the holographic optical element is positioned on a web that is moving past each component of the system wherein each component takes multiple analyses of the holographic optical element.

10. The system of claim 1 further comprising a marking mechanism for the holographic optical element.

11. The system of claim 1 wherein the spectrometer comprises a spectral range in the ultraviolet, visible or near infrared and spectral accuracy of less than or equal to 0.5 nm or less.

12. The system of claim 8 wherein the integrating sphere has a size small enough to register sensitivity of the holographic optical element but large enough to eliminate angular dependence in data collection.

13. The system of claim 1 wherein the light comprises a beam of about 3 mm or less.

14. The system of claim 1 further comprising fiber optics to connect the light source and the spectrometer.

15. The system of claim 1 further comprising a narrow band filter that reduces light incident on the holographic optical element to a bandwidth of about 2-3 nm.

16. The system of claim 1 wherein the scanner comprises a diffusive sheet.

17. The system of claim 1 that is mounted on base.

18. The system of claim 1 wherein the holographic optical element comprises a collection of holographic optical elements with matching performance characteristics.

19. A system for the measurement of optical performance of a holographic optical element comprising one or more stations that perform in-line measurements comprising; (a) a first station for recognizing a part number of the holographic optical element; (b) a second station for monitoring a cosmetic defect of the holographic optical element; (c) a third station for evaluating a measurement of an optical performance of the holographic optical element; and (d) a fourth station for capturing an image of a diffracted beam of the holographic optical element.

20. A method of measuring optical performance of a holographic optical element comprising one or more in-line or in-motion steps of: (a) recognizing part numbers of the holographic optical element, (b) monitoring cosmetic defects of the holographic optical element, (c) evaluating a performance of the holographic optical element, and (d) capturing an image of a diffracted beam of the holographic optical element wherein drift is adjusted.

21. A collection of holographic optical elements comprising holograms with matching performance characteristics.
